(19) United States
(12) Patent Application Publication
(10) Pub. No.: US 2023/0067124 A1
(43) Pub. Date: Mar. 2, 2023

(54) SYSTEM AND METHOD FOR MARKING OF PLAYING FIELDS

(71) Applicant: Siegmund RUFF, Ofterdingen (DE)

(72) Inventor: Siegmund RUFF, Ofterdingen (DE)

(21) Appl. No.: 17/904,145

(22) PCT Filed: Feb. 16, 2021
(86) PCT No.: PCT/EP2021/053742

§ 371 Date: Aug. 12, 2022

(30) Foreign Application Priority Data
Feb. 17, 2020 (AT) A50113/2020

(51) Int. Cl. A63C 19/06; A63C 19/02

(52) U.S. Cl. CPC A63C 19/065; A63C 19/02; A63C 2019/067

(57) ABSTRACT

The invention relates to a system for variable marking of a playing field (1), comprising at least two marking devices (2) designed as laser projectors, an analysis device designed to analyse a calibration pattern (3) projected onto the playing field (1) by means of a marking device (2), as well as designed to determine a distortion function from the calibration pattern (3), a control device designed to determine the position of a marking pattern (4) on the playing field (1), and a transformation device designed to apply the distortion function to the marking pattern (4) in order to obtain a target marking (5). The invention further relates to a method for variable marking of a playing field (1).

The present invention relates to a system and a method for variable marking of playing fields according to the independent patent claims.

Playing fields are used for different sports to indicate the area in which a game takes place. Such playing fields are known, for example, in football, handball, baseball, volleyball and many other sports. The system and method according to the invention is not limited to playing fields for specific sports. Only by way of example, football is referred to below in order to explain the general applicability of the invention and its advantages.

In football, it is customary to take so-called free kicks at places where rules have been broken. Before the ball is played, an opposing player must not be within a certain radius of the point of play. The exact location of the offence is usually marked by the referee by applying a foam spray to the pitch and the minimum distance of the opposing players is also indicated by applying a line of this foam spray.

This approach entails a series of disadvantages. On the one hand, the proper application of the foam spray requires a certain amount of time, which disrupts the flow of the game. On the other hand, the determination of the minimum distance between the point of play and the opposing players is mostly done manually, which can lead to undesired tolerances.

It is therefore an aim of the present invention to provide a system and a method for variable marking of playing fields, which are capable of enabling rapid marking of certain points on the playing field and correctly reproducing, with a low tolerance, any distances that may be necessary between several points.

These and further challenges are solved by the subject matter of the independent claims.

The invention relates to a system for variable marking of a playing field. Optionally, the playing field is selected from one or more of the following: football field, handball field, rugby field, American football field, hockey field, ice hockey field.

Optionally, the system comprises at least two marking devices. Preferably, the marking devices may be designed as laser projectors.

Optionally, the system further comprises an analysis device designed to analyse a calibration projection onto the playing field by one of the marking devices and designed to determine a distortion function from the calibration pattern. The distortion function describes in particular the degree of distortion of a geometric shape projected onto the playing field that results from the specific arrangement of the marking device relative to the playing field.

According to the invention, the calibration pattern is a predetermined, known geometric shape and the calibration projection is the shape that results from projecting the calibration pattern onto a surface. The calibration pattern and the calibration projection are related to each other, in particular via the distortion function.

Optionally, the system further comprises a control device designed to determine the position of a marking pattern on the playing field. The control device may be, for example, a computer with a suitable software for manual control. The control device may also allow for automated control.

Optionally, the system further comprises a transformation device designed to apply the distortion function to the marking pattern to obtain a target marking.

In particular, the transformation device calculates the shape of the target mark using the distortion function in order to be able to depict a specific mark pattern with a given geometry on the playing field.

For example, if the marking pattern is supposed to be a circle, the target marking is distorted by the degree of the distortion function. In particular, the target marking corresponds to the shape that would result if the marking were projected onto a surface oriented perpendicular to the marking device.

Optionally, it is provided that the analysis device comprises an imaging device, wherein the imaging device is designed preferably as a camera. Preferably, the relative positioning of the imaging device compared to the marking devices is known. In a preferred embodiment of the invention, each marking device is associated with an imaging device.

Optionally, four marking devices are provided. This enables particularly efficient coverage of playing fields. In particular, it may be ensured that the angle of irradiation of a marking device is always above a limit value to be determined in order to avoid a too flat irradiation.

Optionally, it is provided that the control device is connected to the tracking device. In particular, the tracking device may be used to automatically track the marking device. For example, the tracking device may be a GPS tracker which may be worn by a person, for example a referee. When a position of the marking is to be determined, the tracking device transmits a signal to the control device and a suitable marking is projected onto the playing field.

Further, the invention relates to the arrangement of a system with a playing field device according to the invention.

Optionally, it is provided that the marking devices are arranged outside an edge of the playing field. This allows complete coverage of the playing field without possible disruption to the match.

Optionally, it is provided that an angle a between the marking device and each position of a marking area is between 30° and 90°. This reduces the risk of blinding match participants with marking devices. Optionally, it is provided that the playing field comprises at least two, preferably four, marking areas.

The invention further relates to a method for variable marking of a playing field.

Optionally, the method further comprises the step of determining the position of a marking pattern on the playing field through a control device.

Optionally, the method comprises the step of using a distortion function on the marking to obtain the target marking trough a transformation device.

Optionally, the method further comprises the step of projecting the target marking onto the playing field through a marking device.

The distortion function may be determined in various ways. Optionally, the distortion function is determined through adaptation of a calibration pattern to an edge of a playing field.

Optionally, the method further comprises the step of projecting the calibration pattern onto the playing field through a marking device.

Optionally, the method comprises the step of analysing the calibration projection through an analysing device.

Optionally, the method further comprises the step of determining the distortion function of the calibration projection through the analysing device.

Optionally, it is provided that the calibration pattern comprises a grid with rectangular, in particular square, grid lines. This calibration pattern is particularly advantageous for an accurate and automated determination of the distortion function.

Optionally, it is provided that the distortion function is determined by means of the analysis device by comparing the calibration pattern with the calibration projection. For example, the comparison may comprise determining a correlation between specified points of the calibration pattern and the calibration projection.

Optionally, it is provided that the distortion function is determined for a plurality of points X₁, X₂, . . . , Xₙ of the playing field. This enables an exact reproduction of marking patterns on different positions of the playing field.

Optionally, it is provided that the marking pattern is formed by several marking components, the marking components being projected onto the playing field by several marking devices. This can reduce shading of parts of the marking that would result, for example, from people being on the playing field.

Optionally, it is provided that the method comprises the further step of determining an edge of the playing field. Optionally, the method according to the invention may prevent the marking device from projecting onto areas that are outside the edge of the playing field. This method step may be accomplished, in particular, by partially shading the marking pattern when it crosses the edge of the playing field.

This protects spectators and other persons who are not on the playing field from exposure to the irradiation of the marking device.

Optionally, it is provided that the calibration pattern is projected by several marking devices onto several marking areas.

Optionally, it is provided that the determination of the position of a target marking on the playing field is carried out by means of a tracking device connected to the control device.

The marking pattern may have any geometrical shape. Examples are: circle, rectangle, square, triangle. Optionally the marking pattern may have a complex shape, for example a text, a logo or the like.

Further features of the invention become apparent from the patent claims, the figures and the description of the exemplary embodiments.

In the following, the present invention will be discussed in detail with reference to exemplary embodiments. The exemplary embodiments merely serve to illustrate the invention and are not intended to limit the scope of protection of the claims.

In the figures:

FIG. 1 shows an arrangement of the system according to the invention with a playing field in schematic perspective view;

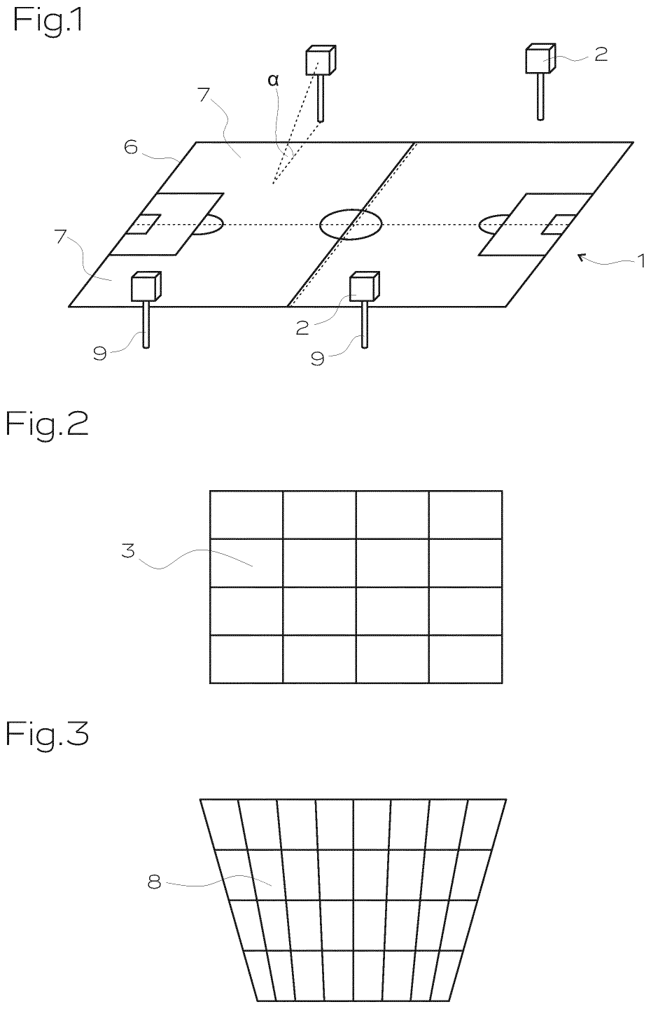

FIG. 2 shows a grid-shaped calibration pattern;

FIG. 3 shows the calibration projection of the calibration pattern from FIG. 2;

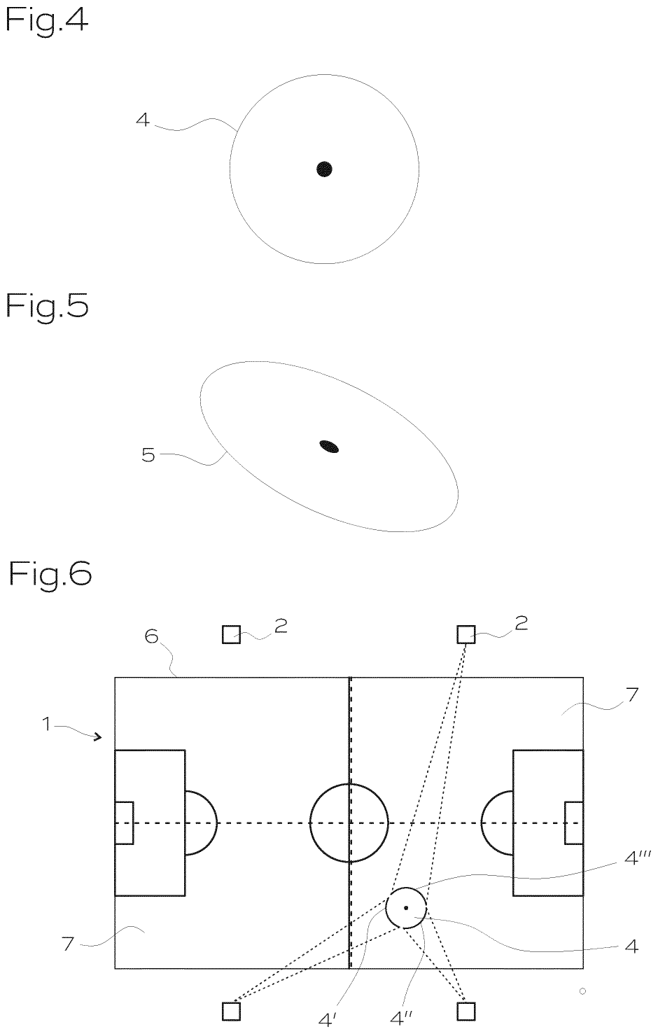

FIG. 4 shows a marking pattern as it should be depicted on a determined position of the playing field;

FIG. 5 shows a target marking in order to depict the marking pattern shown in FIG. 4;

FIG. 6 shows a playing field with a marking pattern in schematic top view; and

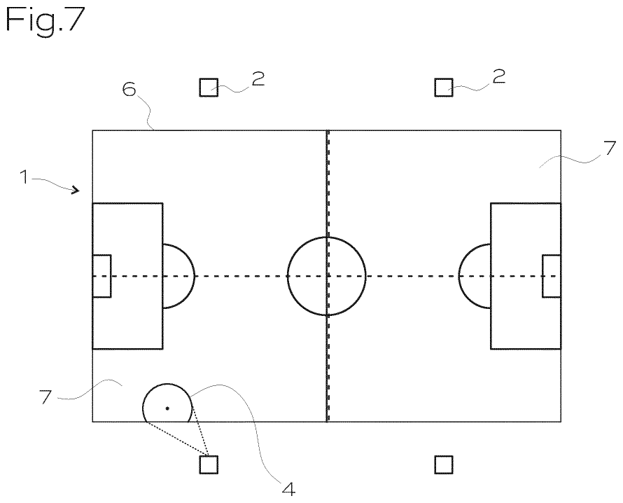

FIG. 7 shows a playing field with further marking patterns in schematic top view.

FIG. 1 shows an arrangement of the system according to the invention with a playing field 1 in schematic perspective view. The system comprises four stand columns 9 that are arranged outside the edge 6 of the playing field 1.

A marking device 2 in the form of a laser projector is arranged on each stand column 9. An imaging device designed as a camera (not shown) is arranged next to each marking device.

In embodiments not shown, the marking devices may also be attached to existing infrastructure, such as a stadium roof.

FIG. 2 shows a grid-shaped calibration pattern 3 as it can be projected by a marking device 2. As the playing field 1 is arranged at an angle to the marking device 2, a distortion results when the calibration pattern 3 is projected onto the playing field 1. The calibration projection 8 is reproduced on the playing field 1.

The calibration projection 8, as seen from one of the imaging devices, is shown in FIG. 3. It can be seen that the calibration projection 8 is distorted in perspective compared to the calibration pattern 3.

The analysis device according to the invention is designed to determine a distortion function from the calibration projection 8 captured by the imaging device and the calibration pattern 3 with predetermined geometry. The inverse distortion function may be used to calculate a marking pattern 4 from a target marking 5, as outlined in FIGS. 4 and 5.

FIG. 4 shows an exemplary target marking 5 depicted as a circle with a marking in its central point. FIG. 5 shows the marking pattern 4 to be projected by a marking device 2, resulting from using the previously determined distortion function.

FIG. 6 shows a playing field 1 in schematic top view with a marking pattern 4 generated by several marking devices 2. Each marking device 2 projects a circular arc shaped marking component 4′, 4″, 4″' onto the playing field 1. The central point can be projected simultaneously by several marking devices 2. This reduces the shadings from people being on the playing field.

FIG. 7 shows a playing field 1 with further marking patterns 4 in schematic top view. The marking pattern 4 is projected onto the playing field 1 by a single marking device 2. As can be seen in FIG. 7, the marking pattern 4 is not a complete circle, but a circular arc, which is cut off by the edge 6 of the playing field 1. The system according to the invention prevents the marking pattern 4 from being projected outside the edge 6 in order to avoid unwanted irradiation on persons outside the playing field 1.

As shown in FIGS. 1, 6, and 7, the playing field 1 is divided into 4 marking areas 7.

The raised arrangement of the marking devices 2 results in an angle a with respect to the horizontal plane between each point of the playing field 1 and the marking device. It is advantageous if the angle at any point of a marking area 7 is kept between 30° and 90° in order to prevent the angle of incidence of the laser irradiation from being too flat and therefore to prevent a hazard to persons located at the playing field.

In the following, a method according to the invention is explained in detail by means of an exemplary embodiment with reference to the figures described above.

The first method step consists in projecting a predetermined grid-shapes calibration pattern 3 onto the playing field 1. Due to the angular arrangement between the marking devices 2 and the playing field 1, the calibration pattern 3 is distorted and a calibration projection 8 becomes visible on the playing field 1.

The imaging device of the system according to the invention produces an image of the calibration projection 8 and transmits it to the analysis device. The analysis device processes the image and compares it to the known geometry of the calibration pattern 3. From this, a distortion function is determined for a plurality of points on the playing field.

Now marking patterns 4 can be reproduced on the playing field 1 without distortion.

For this purpose, the position and the shape of a marking pattern 4 is predetermined in a control device. The transformation device uses the inverse distortion function on the marking pattern 4, and a target marking 5 is projected onto the playing field 1 by the marking devices 2.

By using the inverted distortion function on the marking pattern 4, it is reproduced on the playing field 1 without distortion.

In this example, determining the position of the marking pattern 4 is carried out manually through determination of a software. Alternatively, the determination may also be carried out through a tracking device, for example by automatically determining the position of a person.

### LIST OF REFERENCE SIGNS

1 Playing field
2 Marking device
3 Calibration pattern
4 Marking pattern
4′, 4″, 4″′ Marking component
5 Target marking
6 Edge
7 Marking area
8 Calibration projection

1. A system for variable marking of a playing field (1) comprising
at least two marking devices (2) designed as laser projectors,
an analysis device designed to analyse a calibration pattern (3) projected onto the playing field (1) by means of a marking device (2) and designed to determine a distortion function from the calibration pattern (3),
a control device designed to determine the position of a marking pattern (4) on the playing field (1), and
a transformation device designed to apply the distortion function to the marking pattern (4) to obtain a target marking (5).

2. The system according to claim 1, characterised in that the analysis device comprises an imaging device, wherein the imaging device is designed as a camera.

3. The system according to claim 1, characterised in that four marking devices (2) are provided.

4. The system according to claim 1, characterised in that the control device is connected to a tracking device.

5. An arrangement of a system according to claim 1 with a playing field (1), characterised in that the marking devices (2) are arranged outside an edge (6) of the playing field (1).

6. The arrangement according to claim 5, characterised in that an angle a between the marking device (2) and each position of a marking area (7) is between 30° and 90°.

7. The arrangement according to claim 5, characterised in that playing field
(1) comprises at least two, preferably four, marking areas (7).

8. A method for variable marking of a playing field (1) comprising the following steps:
determining the position of a marking pattern (4) on the playing field (1) by means of a control device,
applying, by means of a transformation device, a distortion function to the marking pattern (4) to obtain a target marking (5),
projecting the target marking (5) onto the playing field (1) by means of a marking device (2).

9. The method according to claim 8, characterised in that the distortion function is determined by:
projecting a calibration pattern (3) onto the playing field (1) by means of a marking device (2),
analysing a calibration projection (8) by means of an analysis device,
determining the distortion function from the calibration projection (8) by means of the analysis device.

10. The method according to claim 9, characterised in that the calibration pattern (3) is a grid with rectangular, in particular square, grid lines.

11. The method according to claim 9, characterised in that the distortion function is determined by means of the analysis device by comparing the calibration pattern (3) with the calibration projection (8).

12. The method according to claim 9, characterised in that the distortion function is determined for a plurality of points X₁, X₂, . . . , Xₙ of the playing field (1) is determined.

13. The method according to claim 8, characterised in that the marking pattern (4) is formed by a plurality of marking parts (4′, 4″, 4″′) wherein the marking parts (4′, 4″, 4″′) are projected onto the playing field (1) by several marking devices (2).

14. The method according to claim 8, characterised in that the method comprises the following further steps:
determining an edge (6) of the playing field (1), and
preventing the marking device (2) from projecting onto areas that are outside the edge (6) of the playing field (1).

15. The method according to claim 9, characterised in that the calibration pattern (3) is projected by a plurality of marking devices (2) onto a plurality of marking areas (7).

16. The method according to claim 8, characterised in that the determining of the position of a marking pattern (4) on the playing field (1) is carried out by means of a tracking device connected to the control device.
